(19) United States
(12) Patent Application Publication
(10) Pub. No.: US 2026/0208981 A1
(43) Pub. Date: Jul. 23, 2026

(54) CONVEYING SYSTEM FOR CONVEYING PRODUCTS

(71) Applicant: Provisur Technologies, Inc., Mokena, IL (US)

(72) Inventor: Klaus-Dieter SCHROFF, Konstanz (DE)

(73) Assignee: Provisur Technologies, Inc., Mokena, IL (US)

(21) Appl. No.: 19/272,760

(22) Filed: Jul. 17, 2025

(30) Foreign Application Priority Data
Jan. 23, 2025 (DE) 10 2025 102 467.7

(51) Int. Cl. B65G 54/02

(52) U.S. Cl. CPC B65G 54/02; B65G 2201/0202; B65G 2207/26

(57) ABSTRACT

A conveying system for conveying products (e.g. food products) has a planar motor drive system for contactless conveying of the products on a planar conveying surface, and a flat cover on the conveying surface of the planar motor drive system. The cover separates the planar motor drive system from the products and protecting it from contamination by the products. The cover is an elastic cover foil.

### TECHNICAL FIELD OF THE DISCLOSURE

The disclosure relates to a conveying system for conveying products (e.g. food products). In addition, the disclosure relates to the novel use of an elastic cover foil for covering a conveying surface of a planar motor drive system in such a conveying system.

### BACKGROUND TO THE DISCLOSURE

In food processing plants for processing food products (e.g. cheese, sausage, meat), the food products are usually transported by conveyor belts along a processing line between different processing stations in which the food products are scanned, weighed, cut, formatted, buffered and packaged, for example.

In a more recent design direction (e.g. DE 10 2021 105 105 A1), a conveyor system with a planar motor drive system is used instead of conveyor belts to convey the food products. For example, the planar motor drive system marketed by the German company Beckhoff Automation GmbH under the product name XPlanar™ can be used here. The products to be conveyed are placed on a product carrier, whereby such product carriers are also referred to as “movers” or “shuttles” according to the relevant technical terminology. The product carrier with the food products arranged on it (e.g. stacks of cheese slices) is then moved contactless over a flat conveying surface by the planar motor drive system, whereby the conveyor path of the product carriers on the conveying surface is freely programmable. To avoid contamination of the planar motor drive system and the machine parts located therein, it is also known to separate the conveying surface of the planar motor drive system from the products by means of a cover. For this purpose, the above-mentioned company Beckhoff Automation GmbH offers a rigid stainless steel plate with a thickness of 0.5 mm, which is attached to the conveying surface of the planar motor drive system. However, this known technical solution for covering the conveying surface of the planar motor drive system has various disadvantages, which are briefly described below.

One disadvantage of the known method of covering the conveying surface with a stainless steel plate is the insufficient flexibility of the stainless steel plate in the event of temperature fluctuations and local heat sources in the machine parts of the planar motor drive system, which leads to unevenness and rippling of the stainless steel plate. In extreme cases, the thermally induced unevenness or wave formation of the stainless steel plate can even lead to a material-removing grinding contact between the underside of the product carriers (“movers”) and the unevenness on the upper side of the stainless steel plate, which must be prevented.

A further disadvantage of the thermally induced unevenness of the stainless steel plate is that troughs form in the upper side of the stainless steel plate, which leads to additional effort when cleaning the stainless steel plate.

In addition, the stainless steel plate offers low serviceability for replacing defective components. For example, the planar motor drive system usually consists of several rectangular tiles that can be replaced individually in the event of a malfunction, but this is made more difficult by the stainless steel plate.

After all, the stainless steel plate is difficult to use in areas of application with higher hygiene requirements, such as the manufacture of food products or the production of pharmaceuticals.

### DESCRIPTION OF THE DISCLOSURE

The disclosure is therefore based on the task of creating a correspondingly improved conveying system which avoids the aforementioned disadvantages as far as possible.

This task is solved by a conveying system according to the main claim.

The conveying system according to the disclosure is generally suitable for conveying products. Preferably, however, the conveying system according to the disclosure is designed to convey food products, such as stacks of cheese slices or slices of sausage. However, the disclosure is not limited to food products in terms of the products to be conveyed, but is also suitable for conveying pharmaceutical products, for example, to mention just one further example. The term “products” used in the context of the disclosure is therefore not limited to the above-mentioned examples. In addition, the principle of a cover foil according to the disclosure can also be implemented when using the conveying system as part of a packaging machine.

In accordance with the state of the art described at the beginning, the conveying system according to the disclosure also has a planar motor drive system to convey the products without contact on a planar conveying surface. For example, this may be the planar motor drive system marketed by the German company Beckhoff Automation GmbH under the product name XPlanar™. Alternatively, it is possible that the planar motor drive system is the system sold by the German company Bosch Rexroth AG under the product name ctrlX FLOW6D®. However, the disclosure is not limited to these specific types with regard to the type of planar motor drive system, but can also be realized with other types of planar motor drive systems.

In accordance with the state of the art described at the beginning, the conveying system according to the disclosure has a flat cover on the conveying surface of the planar motor drive system, the cover separating the planar motor drive system from the products to be conveyed and protecting it from contamination by the products. When cleaning the planar motor drive system, therefore, only the upper side of the flat cover needs to be cleaned, whereas the internal machine parts of the planar motor drive system are protected from contamination during operation and therefore do not need to be cleaned.

The disclosure is now characterized by the fact that the cover is not a stainless steel plate, but an elastic cover foil. This makes it possible to stretch the cover foil elastically over the conveying surface of the planar motor drive system. The elastic tensioning of the cover foil over the conveying surface makes it possible to compensate for temperature fluctuations and corresponding different heat-induced expansions of the cover foil on the one hand and the surrounding frame on the other, so that the cover foil always lies smoothly on the conveying surface and does not form any waves or unevenness. The elastic tensioning of the cover foil on the conveying surface of the planar motor drive system therefore prevents material-abrasive sliding contact between the underside of the product carriers (“movers”) and the cover foil.

In addition, the elastic tensioning of the cover foil on the conveying surface of the planar motor drive system also prevents the disturbing trough formation on the surface of the cover that occurs in the prior art, which reduces the effort required for maintenance of the conveyor system.

In a preferred embodiment of the disclosure, the conveying surface of the planar motor drive system is rectangular and has two opposing narrow sides and two likewise opposing longitudinal sides. The longitudinal sides are preferably longer than the narrow sides, but it is also possible in principle for the conveying surface to be square, so that the longitudinal sides and the narrow sides are then of equal length.

On the one hand, the cover foil is elastically and resiliently fixed to the opposite narrow sides of the conveying surface in order to elastically tension the cover foil between the opposite narrow sides of the conveying surface.

On the other hand, the cover foil is also elastically and resiliently fixed to the opposite longitudinal sides of the conveying surface in order to elastically tension the cover foil between the opposite longitudinal sides of the conveying surface.

The cover foil is therefore preferably elastically tensioned both in the longitudinal direction (i.e. parallel to the longitudinal sides of the conveying surface) and in the transverse direction (i.e. parallel to the narrow sides of the conveying surface). This is advantageous because elastic tensioning in only one direction could result in an undesirable waist formation of the cover foil, i.e. the cover foil would then become narrower in the middle with respect to the tensioning direction and would then no longer be rectangular.

The elastic fixing of the cover foil to the opposite narrow sides of the conveying surface is preferably carried out by a clamping bar, which is aligned parallel to the respective narrow side of the conveying surface. The cover foil is clamped in the opposing clamping bars, preferably over the entire width of the cover foil. This is advantageous because the clamping force for tensioning the cover foil is distributed evenly over the entire width of the cover foil in this way.

The actual elastic tension between the opposite narrow sides of the conveying surface is provided by at least one first spring element that engages with the respective clamping bar. This spring element can, for example, be an expansion screw or a spring (e.g. coil spring) that engages with the respective clamping bar. In the preferred embodiment of the disclosure, four coil springs are provided in each case, which act on the associated clamping bar in order to tension the cover foil, the four coil springs being distributed equidistantly over the length of the clamping bars.

For mechanical tensioning of the cover foil between the opposite narrow sides of the conveying surface of the planar motor drive system, a shaped piece is preferably arranged on each of the opposite narrow sides of the conveying surface, which forms a quarter circle in cross-section and thus forms a rounded guide surface over which the cover foil is guided. For example, the rounded guide surface can have a radius of curvature of at least 2 mm, 5 mm, 1 cm, 2 cm or 5 cm in order to prevent the cover foil from kinking when it is guided over the rounded guide surface. On the inner side of the respective shaped piece, the rounded conveying surface preferably runs horizontally, while the rounded conveying surface on the outer side of the individual shaped pieces preferably runs vertically downwards. The shaped pieces thus convert a tensioning force emanating from the first spring element (e.g. coil spring) and directed vertically downwards into a horizontally directed tensioning force on the cover foil.

The mechanical tensioning of the elastic cover foil between the opposite longitudinal sides of the conveying surface of the planar motor drive system, on the other hand, is preferably carried out in a different way by at least one clamping piece for clamping the cover foil to the opposite longitudinal sides of the conveying surface. Preferably, several clamping pieces are seen in front of, which are distributed along the longitudinal sides of the conveying surface, preferably equidistantly. In the preferred embodiment of the disclosure, four such clamping pieces are provided on each longitudinal side of the conveying surface. In this case, the cover foil is clamped at several separate force application points in the opposing clamping pieces. In contrast to the mechanical tensioning on the narrow sides of the conveying surface, the force is not applied evenly across the entire width of the cover foil, but only at the separate force application points on the clamping pieces. The actual clamping force is applied by at least one second spring element (e.g. coil spring), which acts on each of the clamping pieces. The second spring element (e.g. coil spring) preferably acts in a vertical direction, with the clamping pieces converting the vertically aligned clamping force of the second spring element into a horizontally aligned clamping force on the cover foil.

It has already been mentioned above that the second spring element for mechanically pretensioning the clamping pieces is preferably a coil spring. However, the disclosure is not limited to coil springs with regard to the type of the second spring element.

The above description of the elastic tensioning of the cover foil on the conveying surface of the planar motor drive system shows that the tensioning between the opposing narrow sides of the conveying surface is different from the tensioning between the opposing longitudinal sides of the conveying surface. In the case of tensioning between the opposite narrow sides of the conveying surface, the tensioning force is preferably distributed evenly over the entire width of the cover foil and introduced into the cover foil. In contrast, when the cover foil is elastically tensioned between the opposite longitudinal sides of the conveying surface, the tensioning force is preferably only introduced at the separate force application points located on the clamping pieces.

A preferred embodiment of the conveying system according to the disclosure was described above, in which the clamping takes place by means of the clamping pieces on the longitudinal sides of the conveying surface, while the clamping takes place by means of the clamping bars on the narrow sides of the conveying surface. However, a reverse arrangement is also possible within the scope of the disclosure, in which the clamping takes place by means of the clamping pieces on the narrow sides of the conveying surface, while the clamping takes place by means of the clamping bars on the longitudinal sides of the conveying surface.

It should also be mentioned that the conveying surface of the planar motor drive system is preferably surrounded by a circumferential sealing frame, whereby the cover foil is in sealing contact with the circumferential sealing frame.

In general, it should be mentioned that the cover foil preferably has a very low thickness in order to attenuate the magnetic field generated by the planar motor drive system as little as possible. The thickness of the cover foil is therefore preferably at most 1 mm, 0.5 mm, 0.25 mm or 0.15 mm. The cover foil is preferably so thin that the magnetic field generated by the planar motor drive system is attenuated by the cover foil by less than 10%, 5%, 2% or even less than 1%. However, the cover foil should preferably have a thickness of at least 0.15 mm.

It should also be mentioned that the cover foil is preferably made of plastic or stainless steel, for example a chromium-nickel alloy such as an iron-chromium-nickel-molybdenum alloy (e.g. X2CrNiMo17-12-2). On the one hand, this choice of material is advantageous for the cover foil because the magnetic field of the planar motor drive system is only slightly weakened by the cover foil. On the other hand, this choice of material also offers the advantage that the cover foil hardly corrodes and is easy to clean.

It should also be mentioned that the conveying surface is preferably surrounded by a support frame, which can be made of aluminum or an aluminum alloy, for example. The support frame and the cover foil are preferably made of materials with different coefficients of thermal expansion, for example aluminum for the support frame and stainless steel for the cover foil. This means that the support frame on the one hand and the cover foil on the other expand to different degrees with the temperature fluctuations that occur during operation. The cover foil is elastically tensioned in the support frame, whereby the elastic tensioning of the cover foil compensates for the different thermal expansions of the materials of the support frame and the cover foil.

In addition, it should generally be mentioned that the conveying surface of the planar motor drive system is preferably composed of several rectangular tiles, as is also the case with the prior art described at the beginning. In the conveying system according to the disclosure, however, the individual tiles of the planar motor drive system can preferably be exchanged from below, namely without prior removal of the cover foil. Furthermore, it should be mentioned that the individual tiles of the planar motor drive system do not necessarily have to be rectangular. Rather, the conveying surface of the planar motor drive system can also be composed of differently shaped tiles.

The products to be conveyed are preferably arranged on a product carrier (“mover”) which, together with the product to be conveyed (e.g. stack of sausage slices), is movable without contact above the conveying surface, in particular at a hovering height of 1 mm to 5 mm above the conveying surface. In addition, it should generally be mentioned that the product carrier preferably has a load capacity of at least 100 g, 200 g, 500 g, 1 kg or at least 2 kg.

Finally, the disclosure also claims protection for the novel use of an elastic cover foil for covering a conveying surface of a planar motor drive system in a conveying system for conveying products (e.g. food products), wherein the cover foil is preferably stretched elastically over the conveying surface of the planar motor drive system.

Other advantageous embodiments of the disclosure are characterized in the dependent claims or are explained in more detail below together with the description of the preferred embodiment of the disclosure with reference to the figures.

### BRIEF DESCRIPTION OF THE DRAWINGS

FIG. 1 shows a perspective view of a conveying system according to the disclosure with a planar motor drive system and a cover foil for covering the conveying surface of the planar motor drive system.

FIG. 2 shows a perspective view of the conveyor system from FIG. 1, with the cover foil removed.

FIG. 3 shows an enlarged detailed view of detail Y from FIG. 2.

FIG. 4 shows a detailed view of the cover foil with two clamping bars.

FIG. 5 shows a perspective view of the planar motor drive system without the cover foil.

FIG. 6 shows an enlarged perspective view of detail X from FIG. 5.

FIG. 7 shows a side view of a product carrier (“mover”) of the conveying system according to the disclosure.

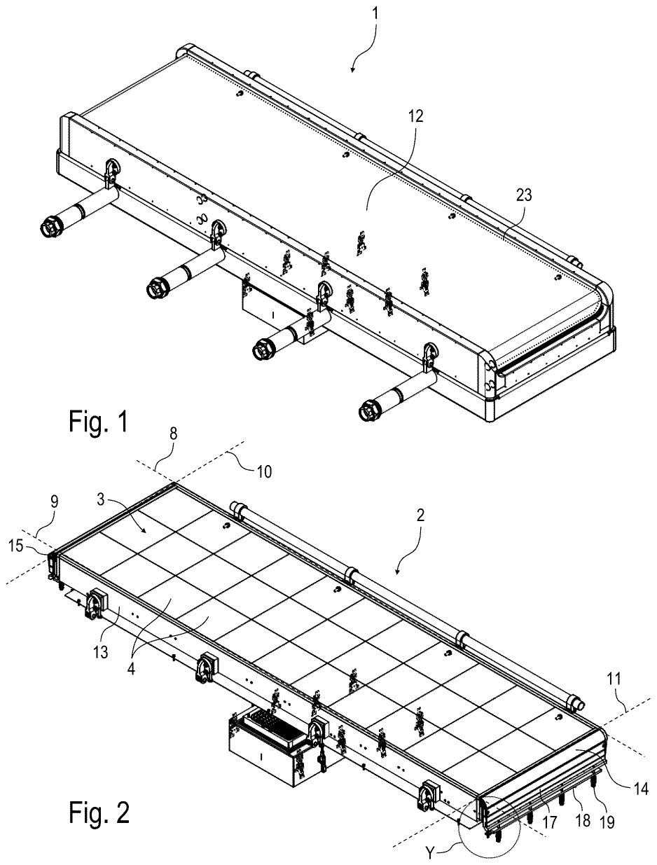

### DETAILED DESCRIPTION OF THE DRAWINGS

In the following, the embodiment shown in the drawings of a conveying system 1 according to the disclosure is described, which is used for conveying food products, which may be stacks of sausage slices or cheese slices, for example. The conveying system according to the disclosure corresponds in part to the known conveying system already mentioned at the beginning, as described in patent application DE 10 2021 105 105 A1. To avoid repetition, reference is therefore also made to this patent application.

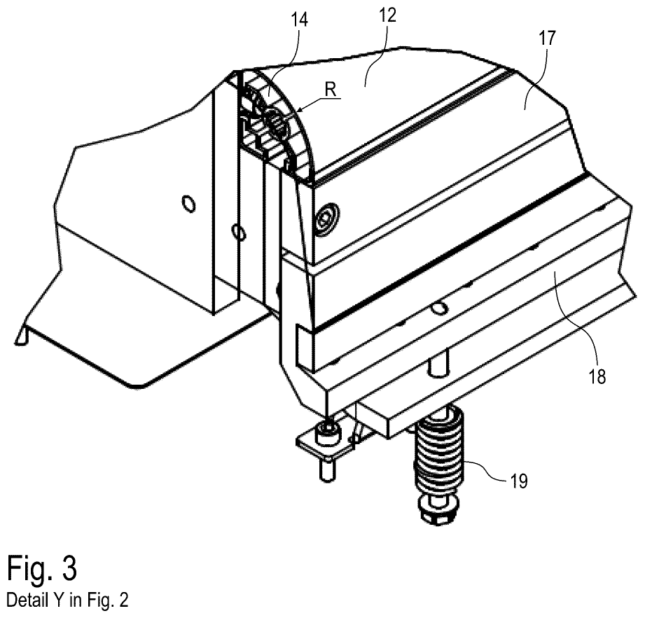

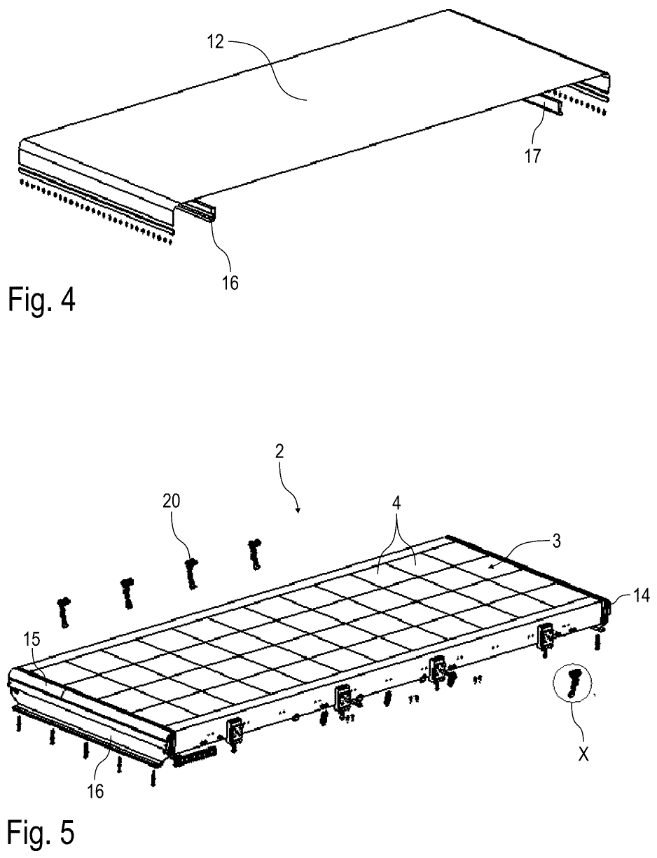

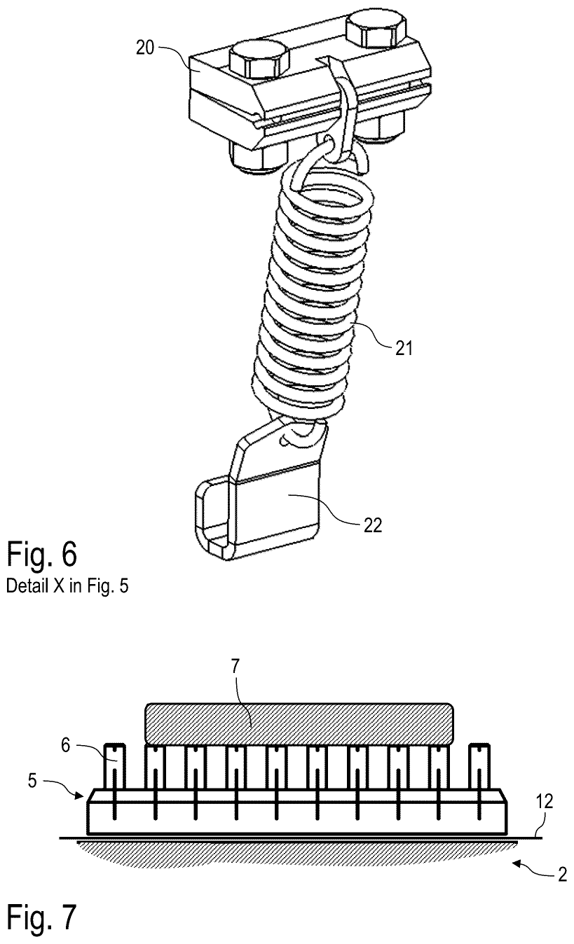

The conveyor system 1 according to the disclosure has a planar motor drive system 2, which is shown in particular in FIGS. 2 and 5. The planar motor drive system 2 is the system known per se, which is marketed by the German company Beckhoff Automation GmbH under the product name XPlanar™

On its upper side, the planar motor drive system 2 has a flat and horizontally aligned conveying surface 3, which is composed of numerous square tiles 4. A product carrier 5 can be conveyed contactlessly on the conveying surface 3, whereby the product carrier 5 is also referred to as a “mover” or “shuttle” in common technical terminology and is shown individually in FIG. 7. For example, the product carrier 5 has numerous pins 6 arranged in a matrix on its upper side, which project vertically upwards and form a loading surface with their upper end face for holding a food product 7. The food product 7 is only shown schematically. The food product 7 may, for example, be a stack of slices of sausage or cheese. The conveying surface 3 of the planar motor drive system 2 is rectangular with two opposing longitudinal sides 8, 9 and two opposing narrow sides 10, 11.

On its upper side, the conveying surface 3 of the planar motor drive system 2 is covered by an elastic cover foil 12, which prevents contamination of the planar motor drive system 2 by the food products 7. The elastic cover foil 12 is elastically tensioned in a support frame 13 both between the opposing longitudinal sides 8, 9 of the conveying surface 3 and between the opposing narrow sides 10, 11 of the conveying surface 3. The elastic tensioning of the cover foil 12 in the support frame 13 is advantageous because the cover foil 12 and the support frame 13 are made of different materials and therefore have different coefficients of thermal expansion. For example, the support frame 13 is made of aluminum, while the cover foil 12 is made of stainless steel X2CrNiMo17-12-2. When heated during operation, the cover foil 12 therefore expands differently than the support frame 13 for thermal reasons. Despite these different thermal expansions, the elastic tensioning of the cover foil 12 in the support frame 13 ensures that the cover foil 12 always lies smoothly on the top of the conveying surface 3. On the one hand, this prevents unevenness in the cover foil 12 from leading to abrasive contact between the underside of the product carrier 5 and the upper side of the cover foil 12. On the other hand, the elastic tensioning of the cover foil 12 also prevents the formation of troughs in the upper side of the cover foil 12, which is disturbing in the prior art, which keeps the cleaning effort to a minimum.

The elastic tensioning of the cover foil 12 in the opposing narrow sides 10, 11 of the conveying surface 3 is now described below.

Thus, on the opposite narrow sides 10, 11 of the conveying surface 3 there are shaped pieces 14, 15, which form a quarter circle in cross-section, as can be seen in particular from the detailed illustration in FIG. 3. The shaped pieces 14 thus form a rounded guide surface for the cover foil 12 so that the cover foil 12 does not kink. The cover foil 12 is therefore guided over the rounded guide surface, which is formed by the two shaped pieces 14, 15 on the opposite narrow sides 10, 11 of the conveying surface 3. To prevent the cover foil 12 from kinking, the guide surface of the shaped pieces 14, 15 each have a radius of curvature of R=5 mm. On the outer sides of the shaped pieces 14, 15, the guide surface is aligned vertically, while the guide surface of the shaped pieces 14, 15 is aligned horizontally on their inner sides.

Furthermore, it should be mentioned that the cover foil 12 is clamped on the opposite narrow sides 10, 11 in a respective clamping bar 16, 17, namely uniformly over the entire width of the respective clamping bar 16, 17. The clamping bar 16, 17 serves here to introduce the elastic clamping force into the cover foil 12. Clamping the cover foil 12 over the entire length of the clamping bars 16, 17 has the advantage that the elastic tensioning force is applied uniformly over the entire width of the cover foil 12 on the narrow sides 10, 11 of the conveying surface 3, so that the cover foil 12 is tensioned uniformly on the narrow sides 10, 11 of the conveying surface 3.

The clamping bars 16, 17 are each held in a yoke 18, as can be seen in particular in FIG. 3. The yoke 18 is in turn pulled downwards by several coil springs 19. The coil springs 19 thus generate a vertically aligned clamping force on the yoke 18 and thus also on the clamping bar 17. This vertically aligned clamping force is then converted by the curved guide surface of the shaped pieces 14, 15 into a horizontally aligned clamping force, which acts on the cover foil 12 and elastically clamps it between the opposing narrow sides 10, 11 of the conveying surface 3.

The elastic tensioning of the cover foil 12 between the opposing longitudinal sides 8, 9 of the conveying surface 3 is now described below.

Four clamping pieces 20 are used for this purpose on each side, which clamp the cover foil 12 laterally at several spatially separated points of application of force. A coil spring 21 acts on each of the individual clamping pieces 20, whereby the coil springs 21 are essentially vertically aligned, as can be seen in particular in FIG. 6. The coil springs 21 are each anchored at their lower end in an abutment 22. The clamping pieces 20 convert the essentially vertically aligned clamping force of the coil springs 21 into a horizontally aligned clamping force, which acts on the cover foil 12 and elastically clamps it between the opposing longitudinal sides 8, 9.

The cover foil 3 is thus tensioned in two directions, namely both in the longitudinal direction (i.e. between the opposing narrow sides 10, 11) and in the transverse direction (i.e. between the opposing longitudinal sides 8, 9). The tensioning between the opposing longitudinal sides 8, 9 prevents the tensioning between the opposing narrow sides 10, 11 from forming a waist of the cover foil 12, i.e. an undesirable tapering of the cover foil 12 between the opposing narrow sides 10, 11.

It should also be mentioned that the supporting frame 13 also forms a circumferential sealing surface 23 on the inside, against which the cover foil 12 rests in a sealing manner. This seal prevents the ingress of liquid into the lower area where electronic components are housed. The sealing surface 23 is only shown as a dashed line in the drawing to make it easier to understand.

It should also be mentioned that the individual tiles 4 of the planar motor drive system 2 can be replaced individually. The individual tiles 4 of the planar motor drive system 2 can be replaced from below. This is advantageous because it is no longer necessary to remove the cover foil 12 in order to replace one of the tiles 4.

The disclosure is not limited to the preferred embodiment example described above. Rather, the disclosure also includes variants and modifications which also make use of the inventive concept and therefore fall within the scope of protection. In particular, the disclosure also claims protection for the subject matter and the features of the dependent claims independently of the claims referred to in each case and, in particular, also without the features of the main claim. The disclosure thus comprises various aspects of the disclosure which enjoy protection independently of each other.

### ADVANTAGES OF THE DISCLOSURE

The disclosure offers various advantages, which are briefly summarized below.
One advantage is that the elastic cover foil compensates for different heat-related expansions of the conveying surface of the planar motor drive system on the one hand and the support frame for the cover foil on the other due to its elastic tensioning over the conveying surface in the event of temperature fluctuations, so that the cover foil always lies smoothly on the conveying surface. On the one hand, this prevents a disturbing trough formation on the upper side of the cover foil. On the other hand, this also prevents material-removing sliding contact between the underside of the product carriers and the upper side of the cover foil.
In contrast to the known cover in the form of a stainless steel plate, the cover foil according to the disclosure shields the magnetic field of the planar motor drive system to a lesser extent.
The conveyor system according to the disclosure is particularly easy to service, as the individual tiles of the planar motor drive system can be replaced without having to remove the cover foil first.
The conveying system according to the disclosure is particularly suitable for use in areas with high hygiene requirements, such as food processing.

### LIST OF REFERENCE SYMBOLS

1 Conveyor system
2 Planar motor drive system of the conveyor system
3 Conveying surface of the planar motor drive system
4 Tiles of the conveying surface of the planar motor drive system
5 Product carrier (“mover”)
6 Pins on the top of the product carrier
7 Food product
8, 9 Longitudinal sides of the conveying surface
10, 11 Narrow sides of the conveying surface
12 Cover foil to cover the conveying surface
13 Support frame
14, 15 Shaped pieces on the narrow sides of the conveying surface with rounded guide surface
16, 17 Clamping bars on the narrow sides of the conveying surface for clamping the cover foil
18 Yoke on the narrow sides of the conveying surface for clamping the clamping bars
19 Coil springs for tensioning the clamping bars using the yoke
20 Clamping pieces on the opposite longitudinal sides of the conveying surface for clamping the cover foil
21 Coil springs for mechanical pretensioning of the clamping pieces
22 Abutment for the coil springs for mechanical pretensioning of the clamping pieces
23 Sealing surface
R Radius of curvature of the guide surface of the shaped pieces

1. A conveying system for conveying products comprising:
a) a planar motor drive system for contactless conveying of the products on a planar conveying surface, and
b) a flat cover on the conveying surface of the planar motor drive system, the cover separating the planar motor drive system from the products and protecting it from contamination by the products,
c) wherein the cover is an elastic cover foil.

2. The conveying system according to claim 1, wherein the cover foil is stretched elastically over the conveying surface of the planar motor drive system.

3. The conveying system according to claim 1, wherein
a) the conveying surface is rectangular with two opposite narrow sides and two opposite longitudinal sides,
b) the cover foil is elastically resiliently fixed to the opposing narrow sides of the conveying surface in order to elastically tension the cover foil between the opposing narrow sides of the conveying surface, and
c) the cover foil is elastically resiliently fixed to the opposite longitudinal sides of the conveying surface in order to elastically tension the cover foil between the opposite longitudinal sides of the conveying surface.

4. The conveying system according to claim 3, wherein
a) a clamping bar is arranged on each of the opposite narrow sides of the conveying surface, the two clamping bars being aligned parallel to the narrow sides of the conveying surface,
b) the cover foil is clamped in the opposing clamping bars over the entire width of the cover foil in the clamping bars, and
c) the opposing clamping bars are each mechanically pretensioned by at least one first spring element in order to elastically tension the cover foil between the opposing narrow sides over the conveying surface.

5. The conveying system according to claim 4, wherein the at least one first spring element for mechanically pretensioning the opposing clamping bars is a coil spring.

6. The conveying system according to claim 3, wherein
a) the cover foil is guided on the opposite narrow sides via a shaped piece in each case, and
b) the shaped pieces each form a rounded guide surface over which the cover foil is guided.

7. The conveying system according to claim 6, wherein the rounded guide surface has a radius of curvature of at least 2 mm in order to prevent the cover foil from kinking when the cover foil is guided over the guide surface.

8. The conveying system according to claim 7, wherein the shaped pieces each form a quarter circle in cross-section, so that the guide surface is aligned horizontally on the inside and vertically downwards on the outside with respect to the conveying surface, so that a vertical tensioning force of the first spring element is converted into a horizontal tensioning force on the cover foil.

9. The conveying system according to claim 3, wherein
a) at least one clamping piece is arranged on each of the opposite longitudinal sides of the conveying surface,
b) the cover foil is clamped in the opposing clamping pieces, and
c) the opposing clamping pieces are each mechanically pretensioned by a second spring element in order to elastically tension the cover foil between the opposing longitudinal sides over the conveying surface.

10. The conveying system according to claim 9, wherein
a) a plurality of clamping pieces are arranged on each of the opposite longitudinal sides of the conveying surface,
b) the clamping pieces are arranged distributed along the longitudinal sides of the conveying surface,
c) the cover foil is clamped at several separate force application points in the opposing clamping pieces, and
d) the opposing clamping pieces are each mechanically pretensioned by a second spring element in order to elastically tension the cover foil between the opposing longitudinal sides over the conveying surface.

11. The conveying systems according to claim 10, wherein the second spring element acts in a vertical direction and the clamping pieces convert the vertical clamping force of the second spring element into a horizontal clamping force on the cover foil.

12. The conveying system according to claim 9, wherein the second spring element for mechanically pretensioning the at least one clamping piece is a coil spring.

13. The conveying system according to claim 3, wherein
a) the cover foil is elastically tensioned between the opposing narrow sides of the conveying surface by a first spring force, the first spring force acting on the cover foil in a manner distributed uniformly over the entire length of the narrow sides of the conveying surface, and
b) the cover foil is elastically tensioned between the opposite longitudinal sides of the conveying surface by a second spring force, the second spring force not acting on the cover foil in a distributed manner over the entire length of the longitudinal sides of the conveying surface, but only at a plurality of separate force application points.

14. The conveying system according to claim 1, wherein
a) the conveying surface is surrounded by a circumferential sealing frame, and
b) the cover foil is in sealing contact with the circumferential sealing frame.

15. The conveying system according to claim 1, wherein
a) the cover foil has a thickness of at most 0.25 mm,
b) the cover foil has a thickness of at least 0.15 mm,
c) the cover foil is made of stainless steel, and
d) the cover foil has a flatness which is more accurate than 0.5 mm.

16. The conveying system according to claim 1, wherein
a) the conveying surface is surrounded by a supporting frame,
b) the supporting frame and the cover foil are made of materials with different coefficients of thermal expansion, and
c) the cover foil is elastically tensioned in the supporting frame, the tensioning of the cover foil compensating for the different coefficients of thermal expansion of the materials of the supporting frame and the cover foil.

17. The conveying system according to claim 1, wherein
a) the conveying surface of the planar motor drive system is composed of a plurality of rectangular tiles, and
b) the individual tiles of the planar motor drive system are replaceable from below without removing the cover foil, and
c) the conveying surface of the planar motor drive system is rectangular.

18. The conveying system according to claim 1, wherein
a) the planar motor drive system operates electromagnetically, and
b) the planar motor drive system has at least one product carrier for receiving the product to be conveyed, the product carrier with the product to be conveyed being movable without contact above the conveying surface, and
c) the product carrier has a load capacity of at least 100 g, and
d) the planar motor drive system generates a magnetic field for contactless conveying of the products and the cover foil attenuates the magnetic field by less than 10%.

19. A method comprising:
providing a conveying surface of a planar motor drive system in a conveying system for conveying products; and
covering the conveying surface with an elastic cover foil.

20. The method of claim 19, wherein the cover foil is stretched elastically over the conveying surface of the planar motor drive system.
